(19) United States
(12) Patent Application Publication
(10) Pub. No.: US 2018/0179476 A1
(43) Pub. Date: Jun. 28, 2018

(54) SOLVENT COMPOSITIONS FOR USE AS HEPTANE REPLACEMENTS

(71) Applicant: TBF ENVIRONMENTAL TECHNOLOGY INC., Surrey (CA)

(72) Inventors: David Anthony Pasin, Vancouver (CA); Shira Devorah Bogner, Vancouver (CA)

(21) Appl. No.: 15/577,145

(22) PCT Filed: May 26, 2016
(86) PCT No.: PCT/IB2016/053075

§ 371 Date: Nov. 27, 2017

Related U.S. Application Data
(60) Provisional application No. 62/168,482, filed on May 29, 2015.

(51) Int. Cl. C11D 7/50; C09D 9/00; C09D 7/20; C09D 11/00

(52) U.S. Cl. CPC C11D 7/5018; C09D 9/005; C11D 7/5022; C09D 11/00; C11D 7/5009; C09D 7/20

(57) ABSTRACT

The present disclosure provides, in part, a solvent composition for use as a heptane replacement. The solvent composition may include a first methylated organosilicon compound, an acetate ester, and either para-Chlorobenzotrifluoride (PCBTF) or a second methylated organosilicon compound or both.

### FIELD OF INVENTION

The present disclosure relates generally to solvent compositions. More specifically, the present disclosure relates to solvent compositions that may be used to replace heptane.

### BACKGROUND OF THE INVENTION

Organic solvents, such as heptane, hexane, methyl ethyl ketone (MEK), acetone, Xylene and toluene, 1,1,1 trichloroethylene and Perchloroethylene and other hydrocarbons, chlorinated or oxygenated solvents are used in a number of applications. Many of these solvents have toxic and/or environmentally deleterious properties. For example, human and animal studies indicate that exposure to these chemicals can have detrimental effects on the central nervous system. Heptane is used as a special-use solvent and as a cleaning agent. Commercial grades of heptane are used as co-solvents for paints and coatings, rubber cement and water-proofing compounds. Heptane is also used as a cleaning agent (degreaser) in the automotive, brake, adhesive and printing industries, as well as in automotive, electronic, contact, precision cleaning and formulated cleaning products for these industries.

Furthermore, many organic solvents are highly volatile and, of the total quantity released to the environment, a significant percentage eventually enters the atmosphere. As such, these solvents have been designated volatile organic compounds (or “VOCs”) and are regulated. Compounds or solvents having lower volatility have been classified as VOC-exempt in the United States (U.S.) by the Environmental Protection Agency (EPA), and/or the South Coast Air Quality Management District (SCAQMD) of California and in Canada by the National Pollutant Release Inventory (NPRI). Heptane is a VOC emitter.

### SUMMARY OF THE INVENTION

The present disclosure provides, in part, a solvent composition including one or more methylated organosilicon compounds, an acetate ester, and para-chlorobenzotrifluoride (PCBTF).

In one aspect, the present disclosure provides a solvent composition including a first methylated organosilicon compound in an amount of about 40% to about 60% by volume of the solvent composition; an acetate ester in an amount of about 20% v/v to about 40% v/v by volume of the solvent composition; and either para-chlorobenzotrifluoride (PCBTF) including about 0% to about 30% by volume of the solvent composition or a second methylated organosilicon compound in an amount of about 0% v/v to about 20% v/v of the solvent composition, or both.

In some embodiments, the first methylated organosilicon compound may include about 45% to about 60% by volume of the solvent composition; the acetate ester may include about 20% v/v to about 35% v/v by volume of the solvent composition; and the para-chlorobenzotrifluoride (PCBTF) may include about 10% to about 25% by volume of the solvent composition.

In alternative embodiments, the first methylated organosilicon compound may include about 40% to about 50% by volume of the solvent composition; the acetate ester may include about 30% v/v to about 40% v/v by volume of the solvent composition; and the second methylated organosilicon compound may include about 15% v/v to about 20% v/v of the solvent composition.

In alternative embodiments, the first methylated organosilicon compound may include about 45% to about 50% by volume of the solvent composition; the acetate ester may include about 30% v/v to about 40% v/v by volume of the solvent composition; the para-chlorobenzotrifluoride (PCBTF) may include about 5% to about 17.5% by volume of the solvent composition; and the second methylated organosilicon compound may include about 2.5% v/v to about 15% v/v of the solvent composition.

In some embodiments, the acetate ester may be VOC-exempt. In some embodiments, the acetate ester may be methyl acetate (MA).

In some embodiments, the first or second methylated organosilicon compound may be VOC-exempt. In some embodiments, the first or second methylated organosilicon compound may be hexamethyldisiloxane (HMDS), octamethyltrisiloxane (OMTS), or decamethyltetrasiloxane (DMTS).

In some embodiments, the first methylated organosilicon compound may be hexamethyldisiloxane (HMDS) in an amount of about 40% to about 50% v/v; (b) the acetate ester may be methyl acetate (MA) in an amount of about 30% v/v to about 40%; and the para-chlorobenzotrifluoride (PCBTF) may be in an amount of about 15% to about 25% v/v.

In some embodiments, the first methylated organosilicon compound may be hexamethyldisiloxane (HMDS) in an amount of about 50% v/v; the acetate ester may be methyl acetate (MA) in an amount of about 25% v/v; and the para-chlorobenzotrifluoride (PCBTF) may be in an amount of about 25% v/v.

In some embodiments, the first methylated organosilicon compound may be hexamethyldisiloxane (HMDS) in an amount of about 45% v/v; the acetate ester may be methyl acetate (MA) in an amount of about 35% v/v; and the para-chlorobenzotrifluoride (PCBTF) may be in an amount of about 20% v/v.

In some embodiments, the first methylated organosilicon compound may be hexamethyldisiloxane (HMDS) in an amount of about 50% v/v; the acetate ester may be methyl acetate (MA) in an amount of about 35% v/v; the para-chlorobenzotrifluoride (PCBTF) may be present in an amount of about 5% v/v; and the second methylated organosilicon compound may be octamethyltrisiloxane (OMTS) in an amount of about 10 v/v.

In some embodiments, the first methylated organosilicon compound may be hexamethyldisiloxane (HMDS) in an amount of about 50% v/v; the acetate ester may be methyl acetate (MA) in an amount of about 35% v/v; and the second methylated organosilicon compound may be octamethyltrisiloxane (OMTS) in an amount of about 15% v/v.

In some embodiments, the solvent composition may have a flash point of at least 4° C.

In some embodiments, the solvent composition may have an evaporation rate of at most 4.3.

In some aspects, the present disclosure provides a kit or commercial package comprising a solvent composition, as described herein, together with instructions for use.

In some embodiments, the present disclosure provides a solvent composition, as described herein, for use as a heptane substitute by volume.

In some embodiments, the present disclosure provides a solvent composition, as described herein, for use as a diluent in the production and manufacture of paints, coatings, inks or rubber cement.

In some embodiments, the present disclosure provides a solvent composition, as described herein, for use as a paint thinner, paint remover, cleaner, or cleaner/degreaser.

In some embodiments, the present disclosure provides a solvent composition, as described herein, for use as a primary or co-solvent in the formulation of hard surface cleaners, for surface preparation, or general and heavy duty degreasing.

Other aspects and features of the present disclosure will become apparent to those ordinarily skilled in the art upon review of the following description.

### DETAILED DESCRIPTION

The present disclosure provides, in part, a solvent composition including a first methylated organosilicon compound, an acetate ester, and either para-chlorobenzotrifluoride (PCBTF) or a second methylated organosilicon compound or both.

By “methylated organosilicon compound,” as used herein, is meant an organic compound with two or more siloxane functional groups saturated with methyl groups. The methylated organosilicon compound may be VOC-exempt.

In some embodiments, the first methylated organosilicon compound may be present in the solvent composition in any amount between about 40% v/v to about 60% v/v, or between about 45% v/v to about 60% v/v, or between about 45% v/v to about 50% v/v, or between about 50% v/v to about 55% v/v, or between about 40% v/v to about 50% v/v, or any value in between the indicated ranges, for example, about 40% v/v, 41% v/v, 42% v/v, 43% v/v, 44% v/v, 45% v/v, 46% v/v, 47% v/v, 48% v/v, 49% v/v, 50% v/v, 51% v/v, 52% v/v, 53% v/v, 54% v/v, 55% v/v, 56% v/v, 57% v/v, 58% v/v, 59% v/v, 60% v/v, etc.

In some embodiments, the second methylated organosilicon compound may be present in the solvent composition in any amount between about 0% v/v to about 20% v/v, or between about 15% v/v to about 20% v/v, or between about 10% v/v to about 20% v/v, or between about 5% v/v to about 10% v/v, or between about 2.5% v/v to about 15% v/v, or any value in between the indicated ranges, for example, about 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, 18% v/v, 19% v/v, 20% v/v, etc.

Hexamethyldisiloxane (HMDS) has the formula C₆H₁₈OSi₂. It is a colourless liquid and has a slight odour. HMDS is VOC-exempt. In some embodiments, the first methylated organosilicon compound may be HMDS, which may be present in the solvent composition in any amount between about 40% v/v to about 60% v/v, or between about 45% v/v to about 60% v/v, or between about 45% v/v to about 50% v/v, or between about 50% v/v to about 55% v/v, or between about 40% v/v to about 50% v/v, or any value in between the indicated ranges, for example, about 40% v/v, 41% v/v, 42% v/v, 43% v/v, 44% v/v, 45% v/v, 46% v/v, 47% v/v, 48% v/v, 49% v/v, 50% v/v, 51% v/v, 52% v/v, 53% v/v, 54% v/v, 55% v/v, 56% v/v, 57% v/v, 58% v/v, 59% v/v, 60% v/v, etc.

In some embodiments, the second methylated organosilicon compound may be HMDS, which may be present in the solvent composition in any amount between about 0% v/v to about 20% v/v, or between about 15% v/v to about 20% v/v, or between about 10% v/v to about 20% v/v, or between about 5% v/v to about 10% v/v, or between about 2.5% v/v to about 15% v/v, or any value in between the indicated ranges, for example, about 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, 18% v/v, 19% v/v, 20% v/v, etc.

Octamethyltrisiloxane (OMTS) has the formula C₈H₂₄O₂Si₃. It is a colourless liquid and has a slight odour. OMTS is VOC-exempt. In some embodiments, the first methylated organosilicon compound may be OMTS, which may be present in the solvent composition in any amount between about 40% v/v to about 60% v/v, or between about 45% v/v to about 60% v/v, or between about 45% v/v to about 50% v/v, or between about 50% v/v to about 55% v/v, or between about 40% v/v to about 50% v/v, or any value in between the indicated ranges, for example, about 40% v/v, 41% v/v, 42% v/v, 43% v/v, 44% v/v, 45% v/v, 46% v/v, 47% v/v, 48% v/v, 49% v/v, 50% v/v, 51% v/v, 52% v/v, 53% v/v, 54% v/v, 55% v/v, 56% v/v, 57% v/v, 58% v/v, 59% v/v, 60% v/v, etc.

In some embodiments, the second methylated organosilicon compound may be OMTS, which may be present in the solvent composition in any amount between about 0% v/v to about 20% v/v, or between about 15% v/v to about 20% v/v, or between about 10% v/v to about 20% v/v, or between about 5% v/v to about 10% v/v, or between about 2.5% v/v to about 15% v/v, or any value in between the indicated ranges, for example, 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, 18% v/v, 19% v/v, 20% v/v, etc.

Decamethyltetrasiloxane (DMTS) has the formula C₁₀H₃₀O₃Si₄. It is a colourless liquid and has a slight odour. DMTS is VOC-exempt. In some embodiments, the first methylated organosilicon compound may be DMTS, which may be present in the solvent composition in any amount between about 40% v/v to about 60% v/v, or between about 45% v/v to about 60% v/v, or between about 45% v/v to about 50% v/v, or between about 50% v/v to about 55% v/v, or between about 40% v/v to about 50% v/v, or any value in between the indicated ranges, for example, about 40% v/v, 41% v/v, 42% v/v, 43% v/v, 44% v/v, 45% v/v, 46% v/v, 47% v/v, 48% v/v, 49% v/v, 50% v/v, 51% v/v, 52% v/v, 53% v/v, 54% v/v, 55% v/v, 56% v/v, 57% v/v, 58% v/v, 59% v/v, 60% v/v, etc.

In some embodiments, the second methylated organosilicon compound may be DMTS, which may be present in the solvent composition in any amount between about 0% v/v to about 20% v/v, or between about 15% v/v to about 20% v/v, or between about 10% v/v to about 20% v/v, or between about 5% v/v to about 10% v/v, or between about 2.5% v/v to about 15% v/v, or any value in between the indicated ranges, for example, about 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, 18% v/v, 19% v/v, 20% v/v, etc.

By “acetate ester,” as used herein, is meant an acetic acid alkyl (C₁-C₄) ester having the formula CH₃CO₂R, where R is C₁-C₄ alkyl. “Alkyl” refers to a straight or branched hydrocarbon chain group consisting solely of carbon and hydrogen atoms, containing no unsaturation and including, for example, from one to four carbon atoms, such as 1, 2, 3, or 4 carbon atoms. The acetate ester may be VOC-exempt.

In some embodiments, the acetate ester may be present in the solvent composition in any amount between about 20% v/v to about 40% v/v, or between about 20% v/v to about 35% v/v, or between about 25% v/v to about 35% v/v, or any value in between the indicated ranges, for example, about 20% v/v, 21% v/v, 22% v/v, 23% v/v, 24% v/v, 25% v/v, 26% v/v, 27 v/v, 28% v/v, 29% v/v, 30% v/v, 31% v/v, 32% v/v, 33% v/v, 34% v/v, 35% v/v, 36% v/v, 37% v/v, 38% v/v, 39% v/v, 40% v/v, etc.

In some embodiments, the acetate ester may be present in the solvent composition in any amount between about 30% v/v to about 40% v/v, or any value in between, for example, 30% v/v, 31% v/v, 32% v/v, 33% v/v, 33% v/v, 35% v/v, 36% v/v, 37% v/v, 38% v/v, 39% v/v, 40% v/v, etc.

In some embodiments, when the second methylated organosilicon compound is present in the solvent composition, the acetate ester may be present in the solvent composition in any amount between about 30% v/v to about 40% v/v, or between about 30% v/v to about 35% v/v, or between about 35% v/v to about 40% v/v, or any value in between the indicated ranges inclusive , for example, about 30% v/v, 31% v/v, 32% v/v, 33% v/v, 34% v/v, 35% v/v, 36% v/v, 37% v/v, 38% v/v, 39% v/v, 40% v/v, etc.

Methyl acetate (MA) has the formula CH₃COOCH₃. It is a flammable liquid with a solubility of 25% in water at room temperature and is not stable in the presence of strong aqueous bases or aqueous acids. MA is VOC-exempt. In some embodiments, the acetate ester may be MA, which may be present in the solvent composition in any amount between about 20% v/v to about 40% v/v, or between about 20% v/v to about 35% v/v, or between about 25% v/v to about 35% v/v, or any value in between the indicated ranges, for example, about 20% v/v, 21% v/v, 22% v/v, 23% v/v, 24% v/v, 25% v/v, 26% v/v, 27 v/v, 28% v/v, 29% v/v, 30% v/v, 31% v/v, 32% v/v, 33% v/v, 34% v/v, 35% v/v, 36% v/v, 37% v/v, 38% v/v, 39% v/v, 40% v/v, etc.

In some embodiments, the MA may be present in the solvent composition in any amount between about 30% v/v to about 40% v/v, or between about 30% v/v to about 35% v/v, or between about 35% v/v to about 40% v/v, or any value in between the indicated ranges inclusive, for example, 30% v/v, 31% v/v, 32% v/v, 33% v/v, 33% v/v, 35% v/v, 36% v/v, 37% v/v, 38% v/v, 39% v/v, 40% v/v, etc.

In some embodiments, when the second methylated organosilicon compound is present in the solvent composition, the MA may be present in the solvent composition in any amount between about 30% v/v to about 40% v/v, or between about 30% v/v to about 35% v/v, or between about 35% v/v to about 40% v/v, or any value in between the indicated ranges inclusive, for example, about 30% v/v, 31% v/v, 32% v/v, 33% v/v, 34% v/v, 35% v/v, 36% v/v, 37% v/v, 38% v/v, 39% v/v, 40% v/v, etc.

tert-Butyl acetate (TBAc) has the formula C₆H₁₂O₂. It is a colorless flammable liquid with a blueberry-like smell. TBAc may be VOC-exempt.

In some embodiments, the acetate ester may be TBAc, which may be present in the solvent composition in any amount between about 20% v/v to about 40% v/v, or between about 20% v/v to about 35% v/v, or between about 25% v/v to about 35% v/v, or any value in between the indicated ranges, for example, about 20% v/v, 21% v/v, 22% v/v, 23% v/v, 24% v/v, 25% v/v, 26% v/v, 27 v/v, 28% v/v, 29% v/v, 30% v/v, 31% v/v, 32% v/v, 33% v/v, 34% v/v, 35% v/v, 36% v/v, 37% v/v, 38% v/v, 39% v/v, 40% v/v, etc.

In some embodiments, TBAc may be present in the solvent composition in any amount between about 30% v/v to about 40% v/v, or between about 30% v/v to about 35% v/v, or between about 35% v/v to about 40% v/v, or any value in between the indicated ranges inclusive, for example, 30% v/v, 31% v/v, 32% v/v, 33% v/v, 33% v/v, 35% v/v, 36% v/v, 37% v/v, 38% v/v, 39% v/v, 40% v/v, etc.

In some embodiments, when the second methylated organosilicon compound is present in the solvent composition, TBAc may be present in the solvent composition in any amount between about 30% v/v to about 40% v/v, or between about 30% v/v to about 35% v/v, or between about 35% v/v to about 40% v/v, or any value in between the indicated ranges inclusive, for example, 30% v/v, 31% v/v, 32% v/v, 33% v/v, 33% v/v, 35% v/v, 36% v/v, 37% v/v, 38% v/v, 39% v/v, 40% v/v, etc.

para-Chlorobenzotrifluoride (PCBTF) has the formula C₇H₄ClF₃. It is an industrial solvent which is heavy (specific gravity of 1.34) with a pungent odour. PCBTF is VOC-exempt. In some embodiments, PCBTF may be present in the solvent composition in any amount between about 0% v/v to about 30% v/v, or any value in between, for example, about 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, 18% v/v, 19% v/v, 20% v/v, 21% v/v, 22% v/v, 23% v/v, 24% v/v, 25% v/v, 26% v/v, 27 v/v, 28% v/v, 29% v/v, 30% v/v, etc.

In some embodiments, the PCBTF may be present in the solvent composition in any amount between about 15% v/v to about 30% v/v, or any value in between, for example, about 15% v/v, 16% v/v, 17% v/v, 18% v/v, 19% v/v, 20% v/v, 21% v/v, 22% v/v, 23% v/v, 24% v/v, 25% v/v, 26% v/v, 27 v/v, 28% v/v, 29% v/v, 30% v/v, etc.

In some embodiments, the PCBTF may be present in the solvent composition in any amount between about 0% v/v to about 17.5 v/v, or any value in between, for example, about 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, etc.

In some embodiments, when the second methylated organosilicon compound is absent from the solvent composition, the PCBTF may be present in the solvent composition in any amount between about 15% v/v to about 30% v/v, or any value in between, for example, about 15% v/v, 16% v/v, 17% v/v, 18% v/v, 19% v/v, 20% v/v, 21% v/v, 22% v/v, 23% v/v, 24% v/v, 25% v/v, 26% v/v, 27 v/v, 28% v/v, 29% v/v, 30% v/v, etc.

In some embodiments, when the second methylated organosilicon compound is present in the solvent composition, the PCBTF may be present in the solvent composition in any amount between about 0% v/v to about 17.5% v/v, for example, about 0% v/v, 1% v/v, 2% v/v, 3% v/v, 4% v/v, 5% v/v, 6% v/v, 7% v/v, 8% v/v, 9% v/v, 10% v/v, 11% v/v, 12% v/v, 13% v/v, 14% v/v, 15% v/v, 16% v/v, 17% v/v, etc.

In some embodiments, a solvent composition according to the present disclosure may include HMDS in an amount of about 50% v/v (about 40.3 wt %), PCBTF in an amount of about 25% v/v (about 35.3 wt %), and MA in an amount of about 25% v/v (about 24.4 wt %).

In some embodiments, a solvent composition according to the present disclosure may include HMDS in an amount of about 45% v/v (about 36.7 wt %), MA in an amount of about 35% v/v (about 34.7 wt %) and PCBTF in an amount of about 20% v/v (about 28.6 wt %).

In some embodiments, a solvent composition according to the present disclosure may include HMDS in an amount of about 50% v/v (about 44.7 wt %), MA in an amount of about 35% v/v (about 37.9 wt %); OMTS in an amount of about 10% v/v (about 9.5 wt %), and PCBTF in an amount of about 5% v/v (about 7.8 wt %).

In some embodiments, a solvent composition according to the present disclosure may include HMDS in an amount of about 50% v/v (about 46.1 wt %), MA in an amount of about 35% v/v (about 39.1 wt %) and OMTS in an amount of about 15% (about 14.8 wt %).

By “about” is meant a variance (plus or minus) from a value or range of 5% or less, for example, 0.5%, 1%, 1.5%, 2.0%, 2.5%, 3.0%, 3.5%, 4.0%, 4.5%, 5.0%, etc.

It is to be understood that varying the amount of a reagent in a solvent composition will generally require a corresponding adjustment (increase or decrease), within the specified ranges, in the amount of the other reagents in a solvent composition according to the present disclosure such that the total percentages of the reagents in the solvent composition equal 100%.

In some embodiments, while not bound to any particular theory, hexamethyldisiloxane, octamethyltrisiloxane and/or decamethyltetrasiloxane may be used as ingredients that do not contribute any hydrogen bonding capability or polarity of a solvent composition according to the present disclosure.

In some embodiments, while not bound to any particular theory, hexamethyldisiloxane, octamethyltrisiloxane and/or decamethyltetrasiloxane may be used to increase the calculated or measured solvency of a solvent composition according to the present disclosure.

In some embodiments, while not bound to any particular theory, octamethyltrisiloxane and/or decamethyltetrasiloxane may also to decrease the calculated or measured evaporation rate and/or increase the flash point of a solvent composition according to the present disclosure.

In some embodiments, while not bound to any particular theory, methyl acetate may be used to increase the calculated or measured evaporation rate of a solvent composition according to the present disclosure.

In some embodiments, while not bound to any particular theory, methyl acetate may be used to increase the calculated or measured solvency of a solvent composition according to the present disclosure.

In some embodiments, while not bound to any particular theory, PCBTF may be used to increase the calculated or measured solvency of a solvent composition according to the present disclosure.

In some embodiments, while not bound to any particular theory, PCBTF may be used to decrease the calculated or measured evaporation rate and/or increase the flash point of a solvent composition according to the present disclosure.

In some embodiments, a solvent composition according to the present disclosure may include reagents that are not classified as hazardous air pollutants (HAPs), as environmentally hazardous, or as ozone-depleting, or as VOCs.

In some embodiments, a solvent composition according to the present disclosure may include compounds or reagents that are VOC-exempt. Such compositions may be useful in reducing VOC emissions. MA, HMDS, OMTS, DMTS and PCBTF are presently VOC-exempt.

A compound's maximum incremental reactivity (MIR) value is a measure of the compound's ability to generate ozone due to photochemical degradation. The lower the MIR value, the less ozone (and, accordingly, the less smog) that is generated by the compound. In some embodiments, a solvent composition according to the present disclosure may have a MIR value lower than heptane (MIR 1.28). In alternative embodiments, compositions according to the present disclosure may have a MIR value of 0.046. In alternative embodiments, compositions according to the present disclosure may have a MIR value of 0.047.

Compositions having a high flash point are useful due to safety reasons, for example, during transport or manufacture or for consumer use. In some embodiments, a solvent composition according to the present disclosure may have a flash point of at least about 4.0° C., for example, at least about 4.5° C., 5.0° C., 5.5° C., 6.0° C., 6.5° C., 7.0° C., 7.5° C., 8.0° C., 8.5° C., 9.0° C., 9.5° C., 10.0° C., 15.0° C., 20.0° C., 25.0° C., 30.0° C., 35.0° C., 40.0° C., or more. In some embodiments, a solvent composition according to the present disclosure may have a flash point of between about 4.0° C. to about 40.0° C., or any value in between. In alternative embodiments, a solvent composition according to the present disclosure may have a flash point of at least about 8.6° C. In alternative embodiments, a solvent composition according to the present disclosure may have a flash point of at least about 5.4° C.

In some embodiments, a solvent composition according to the present disclosure may have low toxicity as determined, for example by one or more of oral LD₅₀ on rats, biodegradability, teratogenicity, carcinogenicity and/or hepatic and renal toxicity measurements, which can be determined using standard methods. In some embodiments, a solvent composition according to the present disclosure may contain reagents classified as non-carcinogenic. In some embodiments, a solvent composition according to the present disclosure may have an oral LD₅₀ of about 5000 mg/kg or more.

Evaporation rates can be expressed relative to the evaporation of n-butyl acetate (=1), as a standard. Evaporation rates may be calculated or experimentally determined. In some embodiments, a solvent composition according to the present disclosure may have a calculated evaporation rate of about 1.5 to about 4.3, or between 3.5 or 4.3, or any value in between or inclusive of this range, for example, about 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, or 4.3 at ambient or room temperatures. In some embodiments, a solvent composition according to the present disclosure may have a calculated evaporation rate of at most 4.0, or at most 4.1, or at most 4.2, or at most 4.3, at ambient or room temperatures. In some embodiments, a solvent composition according to the present disclosure may have an experimentally determined evaporation rate of about 2.0 to about 4.3, or between about 3.5 or about 4.3, or any value in between or inclusive of this range, for example, about 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, or 4.3 at ambient or room temperatures. In some embodiments, a solvent composition according to the present disclosure may have an experimentally determined evaporation rate of at most 4.0, or at most 4.1, or at most 4.2, or at most 4.3, at ambient or room temperatures. Compositions having evaporation rates within these parameters may allow for wider usage in, for example, slower evaporating paints, coatings, inks, adhesives, lubricants, etc.

In some embodiments, a solvent composition according to the present disclosure may have a calculated evaporation rate of about 3.63 at ambient or room temperatures. In alternative embodiments, a solvent composition according to the present disclosure may have a calculated evaporation rate of about 3.99 at ambient or room temperatures. In alternative embodiments, a solvent composition according to the present disclosure may have a calculated evaporation rate of about 4.06 at ambient or room temperatures. In alternative embodiments, a solvent composition according to the present disclosure may have a calculated evaporation rate of about 4.03 at ambient or room temperatures.

In some embodiments, a solvent composition according to the present disclosure may be substantially anhydrous, for example, containing less than 0.02wt % water. In alternative embodiments, a solvent composition according to the present disclosure may contain less than 500 ppm of water.

In some embodiments, a solvent composition according to the present disclosure may be substantially immiscible with water.

In some embodiments, a solvent composition according to the present disclosure may have a purity of, for example, at least 99.5%, for example, at least 99.6%, 99.7%, 99.8%, 99.9%, or 100%. In alternative embodiments, PCBTF may have a purity of, for example, at least 99.5%. In alternative embodiments, HMDS may have a purity of, for example, at least 99.5%. In alternative embodiments, OMTS may have a purity of, for example, at least 99.5%. In alternative embodiments, MA may have a purity of, for example, at least 99.5%.

In some embodiments, a solvent composition according to the present disclosure may have a viscosity of 0.58. In some embodiments, a solvent composition according to the present disclosure may have a viscosity similar to heptane, which is 0.42. In some embodiments, a solvent composition according to the present disclosure may have improved solvency, a Kauri Butanol (Kb) value of 48, relative to, for example heptane, which has a Kb value of 31.This may, in some embodiments, permit the use of less of a solvent composition according to the present disclosure, when compared to compositions containing heptane.

In some embodiments, a solvent composition according to the present disclosure may have a specific gravity of about 0.949 g/ml.

In alternative embodiments, a solvent composition according to the present disclosure may have a specific gravity of about 0.936 g/ml.

In some embodiments, a solvent composition according to the present disclosure may have performance characteristics approximating that of heptane, as described herein or known in the art.

In some embodiments, a solvent composition according to the present disclosure may be recycled through distillation at an appropriate temperature (for example, above the initial boiling point of approximately 70.5° C. (159° F.)).

In alternative embodiments, a solvent composition according to the present disclosure may be recycled through distillation at an appropriate temperature (for example, above initial boiling point of approximately 59° C. (138° F.)).

In some embodiments, a solvent composition according to the present disclosure may have a mild odor. In some embodiments, solvent compositions according to the present disclosure may include reagents that do not have an unpleasant and/or strong odor.

In some embodiments, the present disclosure provides a solvent composition consisting essentially of a first methylated organosilicon compound, an acetate ester, and either para-chlorobenzotrifluoride (PCBTF) or a second methylated organosilicon compound, or both, as described herein. By “consisting essentially of” is meant that inert and/or neutral compounds may be present in the solvent composition without affecting its physical properties, such as flash point or evaporation rate. Accordingly, compounds that may reduce the flash point of the resulting solvent composition below 4° C., or may increase the evaporation rate over 4.3, may be specifically excluded from the solvent compositions according to the present disclosure. In some embodiments, halogenating agents or certain halogen-bearing compounds, including hypohalous, activated halo substituted compounds, and halogen donors (such as tertiary butyl hypochlorite, tertiary butyl hypobromite, diethylbromomalonate, α-bromoacetophenone, bromoacetic acid, cinnamyl bromide, 1,4-dibromo-2-butene, iodoacetic acid, bromodiphenylmethane, 9-bromofluorene, diethyl bromomalonate, benzoyl bromide, cinnamyl bromide, 1,4-dibromo-2-butene, bromoacetic acid, 1,4-dibromo-2,3-butanedione, diethyl dibromomalonate, N-monohaloalkylurethane, N,N-dihaloalkylurethane, N,N-dichloroethylurethane, N,N-dibromoethylurethane, N,N-dichloropropylurethane, N,N-dibromopropylurethane, N,N-dichlorodibenzylurethane, N,N-dibromobenzylurethane dibromoacetonitrile, tribromoacetaldehyde, alpha-bromoisobutyrophenone, ethyl 2-bromoisobutyrate, α,α,α,α-tetrabromo-σ-xylene, 9,10-dibromoanthracene,N-chloroparatoluenesulphonamide, N,N-dihalogenarylsulfonamides such as N,N-dichloro-p-toluenesulfonamide, N,N-dibromotoluenesulfonamide, N,N-dichlorobenzenesulfonamide, N,N-dibromobenzenesulfonamide, halomethyl ether, thiocyanogen, iodine azide, bromine azide, iodine chloride, iodine bromide, trichloroacetic acid iodide, acetic acid bromide, iodine nitrate, alkyl hypohalite, alkyl thionylchloride, aryl thionylchloride, nitrosyl chloride, nitrosyl bromide, etc. are specifically excluded. In some embodiments, cyclohexanes are specifically excluded.

In some embodiments, a solvent composition according to the present disclosure may be useful in replacing heptanes, for example, n-heptane (H₃C(CH₂)₅CH₃ or C₇H₁₆). The solvent compositions can be used, for example, as a solvent in various applications. Examples of contemplated applications include, without limitation: use as paint thinner; use as a paint remover; use as a cleaner; and use as a cleaner/degreaser.

In some embodiments, a solvent composition according to the present disclosure may be useful in the manufacturing and formulation of paints, coatings, rubber cement, as well as in industrial, commercial cleaning/de-greasing applications.

In some embodiments, a solvent composition according to the present disclosure may be useful in paints and coating formulations and/or cleaning, paint removers.

In some embodiments, a solvent composition according to the present disclosure may be useful as a surface preparation, general purpose surface wipe cleaner (for example, prior to painting), general and/or heavy duty degreaser, brake and/or contact cleaner, etc.

In some embodiments, a solvent composition as described herein may be used as a cleaner and degreaser in the automotive industry, as a brake cleaner and as a contact cleaner for electrical components and electronics.

In some embodiments a solvent composition as described herein may be used, as a co-solvent in the formulation of paints, coatings, inks, adhesives, and as a primary or co-solvent in the formulation of hard surface cleaners, for surface preparation, and general and heavy duty degreasing.

It is to be understood that a solvent composition according to the present disclosure can be used in a variety of applications in which heptane is traditionally used, and can be used to replace heptane in such applications. Accordingly, it is to be understood that the ultimate amounts of a solvent composition according to the present disclosure may vary depending on the ultimate use and final composition of the product in which the solvent composition according to the present disclosure is being used.

### EXAMPLES

Candidate compounds were selected using a number of environmental criteria, such as low flammability, safety, VOC-exempt status, and sustainable sourcing.

Candidate compounds were also selected based on their physicochemical properties as, for example, determined from manufacturers' Material Safety Data Sheets, various chemical databases, such as CHEMnetBASE or Chemspider. Candidates with relatively high flash points, low toxicity and low vapor pressures, when compared with heptane, etc. were selected for further testing.

### Example 1

A solvent composition (Formulation 1) was prepared by mixing the following:
50% (v/v) or 40.3% (wt %) HMDS, 99.5% purity, (CAS 107-46-0)
25% (v/v) or 24.4% (wt %) MA, ≥99% purity, (CAS 79-20-9)
25% (v/v) or 35.3% (wt %) PCBTF, 99.5% purity, (CAS 98-56-6)

Formulation 1 has a MIR value of 0.046; a predicted flash point of about 8.6° C.; and a calculated evaporation rate=3.63.

The physical/chemical characteristics of Formulation 1, based on weighted averages (% volume) of the individual components (with the exception of initial boiling point, which was determined experimentally), were as follows:

| Upper Explosive Limit (UEL %) | 17.5 | |
|---|---|---|
| Lower Explosive Limit (LEL %) | 1.2 | |
| Auto Ignition Temp (° C.) | 408.75 | (767.8° F.) |
| Flashpoint (° C.) | 8.6 | (47.4° F.) |
| Initial Boiling Point (° C.) | 70.5 | (158.9° F.) |
| Melting Point (° C.) | −62.3 | (−80° F.) |
| Density (g/ml @ 25° C.) | 0.948 | (7.91 lb/gal) |
| Viscosity (cP @ 25° C.) | 0.615 | |
| Surface Tension (dynes/cm) | 20.05 | |
| Specific Gravity | 0.948 | |
| Solubility in H₂O (g/mL) | 0.0605 | |
| Evaporation Rate (n-Butyl Acetate = 1) | 3.63 | |
| Vapour Pressure (mmHg @ 20° C.) | 65.68 | |
| Vapour Density (mmHg Air = 1) | 4.99 | |
| Kauri Butanol (K_{b}) Value | 43.8 | |
| Maximum Incremental Reactivity (MIR) | 0.046 | |
| Purity (Wt % Min) | 99.5% | |
| Water Content (ppm) | <500 | |
| Colour (Alpha, max) | 5 | (Clear) |

| | |
|---|---|
| Volatility (%) | 100 |
| Hansen solubility parameters (MPA) | |
| δD (dispersion) | 13.55 |
| δP (polar) | 4.26 |
| δH (hydrogen bonding) | 3.08 |

### Example 2

A solvent composition (Formulation 2) was prepared by mixing the following:
45% (v/v) or 36.7% (wt %) HMDS, 99.5% purity, (CAS 107-46-0)
35% (v/v) or 34.7% (wt %) MA, ≥99% purity, (CAS 79-20-9)
20% (v/v) or 28.6% (wt %) PCBTF, 99.5% purity, (CAS 98-56-6)

Formulation 2 has a MIR value of 0.047; a predicted flash point of about 5.4° C.; and a calculated evaporation rate=3.99.

The physical/chemical characteristics of Formulation 2, based on weighted averages (% volume) of the individual components (with the exception of initial boiling point and evaporation rate, which were determined experimentally), were as follows:

| Upper Explosive Limit (UEL %) | 17.5 | |
|---|---|---|
| Lower Explosive Limit (LEL %) | 1.5 | |
| Auto Ignition Temp (° C.) | 412.25 | (744.1° F.) |
| Molecular Weight (g/mol) | — | |
| Flashpoint (° C.) | 5.37 | (41.7° F.) |
| Initial Boiling Point (° C.) | 59.0 | (138.2° F.) |
| Melting Point (° C.) | −67.5 | (−89.5° F.) |
| Density (g/ml @ 25° C.) | 0.936 | (7.81 lb/gal) |
| Viscosity (cP @ 25° C.) | 0.58 | |
| Surface Tension (dynes/cm) | 20.42 | |
| Specific Gravity | 0.936 | |
| Solubility in H₂O (g/mL) | 0.0847 | |
| Evaporation Rate (n-Butyl Acetate = 1) | 2.5 | |
| Vapour Pressure (mmHg @ 20° C.) | 80.6 | |
| Vapour Density (mmHg Air = 1) | 4.66 | |
| Kauri Butanol (K_{b}) Value | 47.6 | |
| Maximum Incremental Reactivity (MIR) | 0.0472 | |
| Purity (Wt % Min) | 99.5% | |
| Water Content (ppm) | <500 | |
| Colour (Alpha, max) | 5 | (Clear) |

| | |
|---|---|
| Volatility (%) | 100 |
| Hansen solubility parameters (MPA) | |
| δD (dispersion) | 13.79 |
| δP (polar) | 4.48 |
| δH (hydrogen bonding) | 3.60 |

### Example 3

A solvent composition (Formulation 3) was prepared by mixing the following:
50% (v/v) or 44.7% (wt %) HMDS, 99.5% purity, (CAS 107-46-0)
35% (v/v) or 37.9% (wt %) MA, ≥99% purity, (CAS 79-20-9)
5% (v/v) or 7.8% (wt %) PCBTF, 99.5% purity, (CAS 98-56-6)
10% (v/v) or 9.5% (wt %) OMTS, 99.5% purity, (CAS 107-51-7)

Formulation 3 has an MIR value of 0.031; a predicted flash point of about 2.35° C.; and a calculated evaporation rate=4.06.

### Example 4

A solvent composition (Formulation 4) was prepared by mixing the following:
50% (v/v) or 46.1% (wt %) HMDS, 99.5% purity, (CAS 107-46-0)
35% (v/v) or 39.1% (wt %) MA, ≥99% purity, (CAS 79-20-9)
15% (v/v) or 14.8% (wt %) OMTS, 99.5% purity, (CAS 107-51-7)

Formulation 3 has an MIR value of 0.025; a predicted flash point of about 1.90° C.; and a calculated evaporation rate=4.03.

### Example 5

A solvent composition (Formulation 5) was prepared by mixing the following:
40% (v/v) or 36.2% (wt %) HMDS, 99.5% purity, (CAS 107-46-0)
40% (v/v) or 44.3% (wt %) MA, ≥99% purity, (CAS 79-20-9)
20% (v/v) or 19.5% (wt %) OMTS, 99.5% purity, (CAS 107-51-7)

Formulation 5 has an MIR value of 0.029; a predicted flash point of about 3.04° C.; and a calculated evaporation rate=3.95.

### Example 6

A solvent composition (Formulation 6) was prepared by mixing the following:
45% (v/v) or 41.1% (wt %) HMDS, 99.5% purity, (CAS 107-46-0)
35% (v/v) or 39.2% (wt %) MA, ≥99% purity, (CAS 79-20-9)
20% (v/v) or 19.7% (wt %) OMTS, 99.5% purity, (CAS 107-51-7)

Formulation 6 has an MIR value of 0.025; a predicted flash point of about 3.57° C.; and a calculated evaporation rate=3.84.

### Example 7

A solvent composition (Formulation 7) was prepared by mixing the following:
50% (v/v) or 44.7% (wt %) HMDS, 99.5% purity, (CAS 107-46-0)
30% (v/v) or 32.9% (wt %) MA, ≥99% purity, (CAS 79-20-9)
5% (v/v) or 7.9% (wt %) PCBTF, 99.5% purity, (CAS 98-56-6)
15% (v/v) or 14.5% (wt %) OMTS, 99.5% purity, (CAS 107-51-7)

Formulation 7 has an MIR value of 0.027; a predicted flash point of about 4.55° C.; and a calculated evaporation rate=3.71.

### Example 8

A solvent composition (Formulation 8) was prepared by mixing the following:
50% (v/v) or 43.4% (wt %) HMDS, 99.5% purity, (CAS 107-46-0)
30% (v/v) or 31.9% (wt %) MA, ≥99% purity, (CAS 79-20-9)
10% (v/v) or 15.3% (wt %) PCBTF, 99.5% purity, (CAS 98-56-6)
10% (v/v) or 9.4% (wt %) OMTS, 99.5% purity, (CAS 107-51-7)

Formulation 8 has an MIR value of 0.033; a predicted flash point of about 5.0° C.; and a calculated evaporation rate=3.81.

### Example 9

A solvent composition (Formulation 9) was prepared by mixing the following:
50% (v/v) or 41.9% (wt %) HMDS, 99.5% purity, (CAS 107-46-0)
35% (v/v) or 36.0% (wt %) MA, ≥99% purity, (CAS 79-20-9)
15% (v/v) or 22.2% (wt %) PCBTF, 99.5% purity, (CAS 98-56-6)

Formulation 9 has an MIR value of 0.042; a predicted flash point of about 3.25° C.; and a calculated evaporation rate=4.14.

### Example 10

A solvent composition (Formulation 10) was prepared by mixing the following:
50% (v/v) or 41.0% (wt %) HMDS, 99.5% purity, (CAS 107-46-0)
30% (v/v) or 30.1% (wt %) MA, ≥99% purity, (CAS 79-20-9)
20% (v/v) or 28.9% (wt %) PCBTF, 99.5% purity, (CAS 98-56-6)

Formulation 10 has an MIR value of 0.044; a predicted flash point of about 5.9° C.; and a calculated evaporation rate=3.88.

### Example 11

A solvent composition (Formulation 11) was prepared by mixing the following:
55% (v/v) or 45.5% (wt %) HMDS, 99.5% purity, (CAS 107-46-0)
25% (v/v) or 25.4% (wt %) MA, ≥99% purity, (CAS 79-20-9)
20% (v/v) or 29.2% (wt %) PCBTF, 99.5% purity, (CAS 98-56-6)

Formulation 11 has an MIR value of 0.04; a predicted flash point of about 6.4° C.; and a calculated evaporation rate=3.77.

### Example 12

A solvent composition (Formulation 12) was prepared by mixing the following:
55% (v/v) or 46.5% (wt %) HMDS, 99.5% purity, (CAS 107-46-0)
30% (v/v) or 31.1% (wt %) MA, ≥99% purity, (CAS 79-20-9)
15% (v/v) or 22.4% (wt %) PCBTF, 99.5% purity, (CAS 98-56-6)

Formulation 12 has an MIR value of 0.038; a predicted flash point of about 3.78° C.; and a calculated evaporation rate=4.03.

### Example 13

A solvent composition (Formulation 13) was prepared by mixing the following:
55% (v/v) or 44.5% (wt %) HMDS, 99.5% purity, (CAS 107-46-0)
20% (v/v) or 19.8% (wt %) MA, ≥99% purity, (CAS 79-20-9)
25% (v/v) or 35.7% (wt %) PCBTF, 99.5% purity, (CAS 98-56-6)

Formulation 13 has an MIR value of 0.042; a predicted flash point of about 9.1° C.; and a calculated evaporation rate=3.52.

### Example 14

A solvent composition (Formulation 14) was prepared by mixing the following:
60% (v/v) or 52.4% (wt %) HMDS, 99.5% purity, (CAS 107-46-0)
30% (v/v) or 32.2% (wt %) MA, ≥99% purity, (CAS 79-20-9)
10% (v/v) or 15.4% (wt %) PCBTF, 99.5% purity, (CAS 98-56-6)

Formulation 14 has an MIR value of 0.033; a predicted flash point of about 1.7° C.; and a calculated evaporation rate=4.17.

### Example 15

A solvent composition (Formulation 15) was prepared by mixing the following:
60% (v/v) or 51.2% (wt %) HMDS, 99.5% purity, (CAS 107-46-0)
25% (v/v) or 26.2% (wt %) MA, ≥99% purity, (CAS 79-20-9)
15% (v/v) or 22.6% (wt %) PCBTF, 99.5% purity, (CAS 98-56-6)

Formulation 15 has an MIR value of 0.035; a predicted flash point of about 4.3° C.; and a calculated evaporation rate=3.92.

### Example 16

A solvent composition (Formulation 16) was prepared by mixing the following:
60% (v/v) or 50.0% (wt %) HMDS, 99.5% purity, (CAS 107-46-0)
20% (v/v) or 20.5% (wt %) MA, ≥99% purity, (CAS 79-20-9)
20% (v/v) or 29.4% (wt %) PCBTF, 99.5% purity, (CAS 98-56-6)

Formulation 16 has an MIR value of 0.036; a predicted flash point of about 7.0° C.; and a calculated evaporation rate=3.66.

### Example 17

A solvent composition (Formulation 17) was prepared by mixing the following:
45% (v/v) or 37.1% (wt %) HMDS, 99.5% purity, (CAS 107-46-0)
35% (v/v) or 35.3% (wt %) MA, ≥99% purity, (CAS 79-20-9)
17.5% (v/v) or 25.4% (wt %) PCBTF, 99.5% purity, (CAS 98-56-6)
2.5% (v/v) or 2.2% (wt %) OMTS, 99.5% purity, (CAS 107-51-7)

Formulation 17 has an MIR value of 0.044; a predicted flash point of about 5.2° C.; and a calculated evaporation rate=3.97.

### Example 18

Formulation 18: 100% Heptanes.

### Example 19

A solvent composition (Formulation 19) having about:
22.85% (v/v) or 19.61% (wt %) HMDS,
74.91% (v/v) or 78.43% (wt %) MA,
   has a calculated flash point of −7.35° C. and a calculated evaporation rate of 5.51.

### Example 20

A solvent composition (Formulation 20) having:
22.85% (v/v) or 19.61% (wt %) HMDS,
74.91% (v/v) or 78.43% (wt %) MA, and
2.24% (v/v) or 1.96% (wt %) Cyclohexane,
   has a calculated flash point of −7.80° C. and a calculated evaporation rate of 5.64.

### Example 21

A solvent composition (Formulation 21) having about:
33.58% (v/v) or 29.41% (wt %) HMDS,
64.23% (v/v) or 68.63% (wt %) MA,
   has a calculated flash point of −6.22° C., and a calculated evaporation rate of 5.26.

### Example 22

A solvent composition (Formulation 22) having:
33.58% (v/v) or 29.41% (wt %) HMDS,
64.23% (v/v) or 68.63% (wt %) MA,
2.20% (v/v) or 1.96% (wt %) Cyclohexane,
   has a calculated flash point of −6.66° C. and a calculated evaporation rate of 5.38.

### EXAMPLE 23

A solvent composition (Formulation 23) having about:
83.07% (v/v) or 78.43% (wt %) MA,
14.44% (v/v) or 19.61% (wt %) PCBTF,
   has a calculated flash point of −2.10° C. and a calculated evaporation rate of 5.28.

### Example 24

A solvent composition (Formulation 24) having about:
83.07% (v/v) or 78.43% (wt %) MA,
14.44% (v/v) or 19.61% (wt %) PCBTF,
2.48% (v/v) or 1.96% (wt %) Cyclohexane,
   has a calculated flash point of −2.59° C. and a calculated evaporation rate of 5.42.

### Example 25

A solvent composition (Formulation 25) having about:
29.07% (v/v) or 25% (wt %) HMDS,
70.53% (v/v) or 74% (wt %) MA,
   has a calculated flash point of −6.88° C., and a calculated evaporation rate of 5.48.

### Example 26

A solvent composition (Formulation 26) having about:
31.34% (v/v) or 25% (wt %) HMDS,
50.35% (v/v) or 49% (wt %) MA,
17.87% (v/v) or 25% (wt %) PCBTF,
   has a calculated flash point of 2.85° C., and a calculated evaporation rate of 4.47.

Several compounds were combined in different initial blends (Table 1). Blends were formulated with predicted flash points >0° C. (32° F.) and calculated evaporation rates within the range of 3.0-4.2. The blends or formulations described herein were selected through standardized performance tests on solvency of lithium grease, as well as evaporation rate.

The solvent blends were compared to heptane (Formulation 18, Table 1), in the form of commercial brake cleaner (60-100% heptanes, 7-13% isopropanol, 1-5% CO₂), as well as Formulations 19-26.

The odor of the blends was also tested empirically. Evaporation rates were calculated (Calculated Evaporation Rate, Table 1) based on weight averages (% by volume) of individual components, as compared to n-butyl acetate. Evaporation rates were also measured (Experimental Evaporation, Table 1) based on approximate time (in seconds) for 95% of 0.3 ml of the blend to evaporate (by visual inspection).

TABLE 1

| | | | | | | | | Calculated | | Calculated | Experimental |
|---|---|---|---|---|---|---|---|---|---|---|---|
| Formulation | Hexamethyl | Octamethyl | Decamethyl | p-Chlorobenzo | Methyl | | | Flash | | Evaporation | Evaporation |
| No. | disiloxane | trisiloxane | tetrasiloxane | trifluoride | Acetate | Heptane | Cyclohexane | Point | | Rate | (seconds) |
| 1 | 50 | 0 | 0 | 25 | 25 | 0 | 0 | 8.55° | C. | 3.63 | 85 |
| 2 | 45 | 0 | 0 | 20 | 35 | 0 | 0 | 5.37° | C. | 3.99 | 100 |
| 3 | 50 | 10 | 0 | 5 | 35 | 0 | 0 | 2.35° | C. | 4.06 | 125 |
| 4 | 50 | 15 | 0 | 0 | 35 | 0 | 0 | 1.9° | C. | 4.03 | 160 |
| 5 | 40 | 20 | 0 | 0 | 40 | 0 | 0 | 3.04° | C. | 3.92 | 180 |
| 6 | 45 | 20 | 0 | 0 | 35 | 0 | 0 | 3.57° | C. | 3.81 | 185 |
| 7 | 50 | 15 | 0 | 5 | 30 | 0 | 0 | 4.55° | C. | 3.71 | 150 |
| 8 | 50 | 10 | 0 | 10 | 30 | 0 | 0 | 5.00° | C. | 3.79 | 120 |
| 9 | 50 | 0 | 0 | 15 | 35 | 0 | 0 | 3.25° | C. | 4.14 | 75 |
| 10 | 50 | 0 | 0 | 20 | 30 | 0 | 0 | 5.9° | C. | 3.88 | 90 |
| 11 | 55 | 0 | 0 | 20 | 25 | 0 | 0 | 6.43° | C. | 3.77 | 120 |
| 12 | 55 | 0 | 0 | 15 | 30 | 0 | 0 | 3.78° | C. | 4.03 | 85 |
| 13 | 55 | 0 | 0 | 25 | 20 | 0 | 0 | 9.08° | C. | 3.52 | 80 |
| 14 | 60 | 0 | 0 | 10 | 30 | 0 | 0 | 1.66° | C. | 4.17 | 90 |
| 15 | 60 | 0 | 0 | 15 | 25 | 0 | 0 | 4.31° | C. | 3.92 | 85 |
| 16 | 60 | 0 | 0 | 20 | 20 | 0 | 0 | 6.96° | C. | 3.66 | 90 |
| 17 | 45 | 2.5 | 0 | 17.5 | 35 | 0 | 0 | 5.15° | C. | 3.97 | 130 |
| 18 | 0 | 0 | 0 | 0 | 0 | 100 | 0 | −4° | C. | 3.3 | 70 |
| 19 | 22.85 | 0 | 0 | 0 | 74.91 | 0 | 0 | −7.35° | C. | 5.51 | — |
| 20 | 22.85 | 0 | 0 | 0 | 74.91 | 0 | 2.24 | −7.80° | C. | 5.64 | — |
| 21 | 33.58 | 0 | 0 | 0 | 64.23 | 0 | 0 | −6.22° | C. | 5.26 | — |
| 22 | 33.58 | 0 | 0 | 0 | 64.23 | 0 | 2.20 | −6.66° | C. | 5.38 | — |
| 23 | 0 | 0 | 0 | 14.44 | 83.07 | 0 | 0 | −2.10° | C. | 5.28 | — |
| 24 | 0 | 0 | 0 | 14.44 | 83.07 | 0 | 2.48 | −2.59° | C. | 5.42 | — |
| 25 | 29.07 | 0 | 0 | 0 | 70.53 | 0 | 0 | −6.88° | C. | 5.48 | — |
| 26 | 31.34 | 0 | 0 | 17.87 | 50.35 | 0 | 0 | 2.85° | C. | 4.47 | — |

Formulations 1 to 17 were observed to dissolve lithium grease with efficiency comparable to Formulation 18, commercial brake cleaner (60-100% heptanes, 7-13% isopropanol, 1-5% CO₂).

Formulations including octamethyltrisiloxane (Formulations 3-8, 17) were found to have relatively slow experimental evaporation rates.

Formulations with 60% (v/v) hexamethyldisiloxane (Formulations 14-16) were found to have relatively fast experimental evaporation rates.

Formulations 1-4 were subjected to qualitative degreasing tests and were found to perform with comparable or superior efficiency compared to commercial brake cleaner (60-100% heptanes, 7-13% isopropanol, 1-5% CO₂).

Formulations 1 to 17 exhibited superior flash points and/or evaporation rates compared to Formulations 19 to 26.

In the preceding description, for purposes of explanation, numerous details are set forth in order to provide a thorough understanding of the examples. However, it will be apparent to one skilled in the art that these specific details are not required.

The above-described examples are intended to be exemplary only. Alterations, modifications and variations can be effected to the particular examples by those of skill in the art without departing from the scope, which is defined by the claims appended hereto.

All citations are hereby incorporated by reference.

1. A solvent composition comprising:
i) a first methylated organosilicon compound comprising about 40% to about 60% by volume of the solvent composition;
ii) an acetate ester comprising about 20% v/v to about 40% v/v by volume of the solvent composition; and
iii) para-Chlorobenzotrifluoride (PCBTF) comprising about 0% to about 30% by volume of the solvent composition and/or a second methylated organosilicon compound comprising about 0% v/v to about 20% v/v of the solvent composition.

2. The solvent composition of claim 1 wherein:
i) the first methylated organosilicon compound comprises about 45% to about 60% by volume of the solvent composition;
ii) the acetate ester comprises about 20% v/v to about 35% v/v by volume of the solvent composition; and
iii) the para-Chlorobenzotrifluoride (PCBTF) comprises about 10% to about 25% by volume of the solvent composition.

3. The solvent composition of claim 1 wherein:
i) the first methylated organosilicon compound comprises about 40% to about 50% by volume of the solvent composition;
ii) the acetate ester comprises about 30% v/v to about 40% v/v by volume of the solvent composition; and
iii) the second methylated organosilicon compound comprises about 15% v/v to about 20% v/v of the solvent composition.

4. The solvent composition of claim 1 wherein:
i) the first methylated organosilicon compound comprises about 45% to about 50% by volume of the solvent composition;
ii) the acetate ester comprises about 30% v/v to about 40% v/v by volume of the solvent composition;
iii) the para-Chlorobenzotrifluoride (PCBTF) comprises about 5% to about 17.5% by volume of the solvent composition; and
iv) the second methylated organosilicon compound comprises about 2.5% v/v to about 15% v/v of the solvent composition.

5. The solvent composition of claim 1 wherein the acetate ester is VOC-exempt.

6. The solvent composition of claim 1 wherein the acetate ester is methyl acetate (MA).

7. The solvent composition of claim 1 wherein the first or second methylated organosilicon compound is VOC-exempt.

8. The solvent composition of claim 1 wherein the first methylated organosilicon compound, or the second methylated organosilicon compound if present, is hexamethyldisiloxane (HMDS), octamethyltrisiloxane (OMTS), or decamethyltetrasiloxane (DMTS).

9. The solvent composition of claim 1 wherein the first methylated organosilicon compound is hexamethyldisiloxane (HMDS).

10. The solvent composition of claim 1 wherein the second methylated organosilicon compound, if present, is octamethyltrisiloxane (OMTS).

11. The solvent composition of claim 1 wherein:
i) the first methylated organosilicon compound is hexamethyldisiloxane (HMDS) in an amount of about 40% to about 50% v/v;
ii) the acetate ester is methyl acetate (MA) in an amount of about 30% v/v to about 40%; and
iii) the para-chlorobenzotrifluoride (PCBTF) is in an amount of about 15% to about 25% v/v.

12. The solvent composition of claim 1 wherein:
i) the first methylated organosilicon compound is hexamethyldisiloxane (HMDS) in an amount of about 50% v/v;
ii) the acetate ester is methyl acetate (MA) in an amount of about 25% v/v; and
iii) the para-chlorobenzotrifluoride (PCBTF) is in an amount of about 25% v/v.

13. The solvent composition of claim 1 wherein:
i) the first methylated organosilicon compound is hexamethyldisiloxane (HMDS) in an amount of about 45% v/v;
ii) the acetate ester is methyl acetate (MA) in an amount of about 35% v/v; and
iii) the para-chlorobenzotrifluoride (PCBTF) is in an amount of about 20% v/v.

14. The solvent composition of claim 1 wherein:
i) the first methylated organosilicon compound is hexamethyldisiloxane (HMDS) in an amount of about 50% v/v;
ii) the acetate ester is methyl acetate (MA) in an amount of about 35% v/v;
iii) the para-chlorobenzotrifluoride (PCBTF) is present in an amount of about 5% v/v; and
iv) the second methylated organosilicon compound is Octamethyltrisiloxane (OMTS) in an amount of about 10% v/v.

15. The solvent composition of claim 1 wherein:
i) the first methylated organosilicon compound is hexamethyldisiloxane (HMDS) in an amount of about 50% v/v;
ii) the acetate ester is methyl acetate (MA) in an amount of about 35% v/v; and
iii) the second methylated organosilicon compound is Octamethyltrisiloxane (OMTS) in an amount of about 15% v/v.

16. The solvent composition of claim 1 wherein the solvent composition has a flash point of at least 4° C.

17. The solvent composition of claim 1 wherein the solvent composition has an evaporation rate of at most 4.3.

18. A kit or commercial package comprising the solvent composition of claim 1 together with instructions for use.

19. The solvent composition of claim 1 wherein the solvent composition is for use as a heptane substitute by volume.

20. The solvent composition or kit of claim 1 for use as a diluent in the production and manufacture of paints, coatings, inks or rubber cement, or for use as a paint thinner, paint remover, cleaner, or cleaner/degreaser, or for use as a primary or co-solvent in the formulation of hard surface cleaners, for surface preparation, or general and heavy duty degreasing.

21.-22. (canceled)
